(19) United States
(12) Patent Application Publication
(10) Pub. No.: US 2011/0085871 A1
(43) Pub. Date: Apr. 14, 2011

(54) Coupling Mechanism For Connecting A Toolholder Assembly And A Machine Tool

(75) Inventor: Curtis Peter Rellick, Latrobe, PA (US)

(73) Assignee: Kennametal Inc., Latrobe, PA (US)

(21) Appl. No.: 12/577,830

(22) Filed: Oct. 13, 2009

(51) Int. Cl. B23C 5/26

(52) U.S. Cl. 409/234

(57) ABSTRACT

A coupling mechanism for connecting a toolholder assembly and a machine tool. The coupling mechanism includes a first component configured for removably securing the toolholder assembly to the machine tool, wherein the first component includes an axial forward end defining a bore that extends axially to an axial rearward end of the first component to form an inner surface of the first component, the first component having a plurality of apertures disposed circumferentially thereabout that extend from an outer surface of the first component to the inner surface of the first component. The coupling mechanism further includes a second component integrally formed with the first component and configured for interacting with the machine tool to position the toolholder assembly relative to the machine tool, wherein the second component defines a positioning groove on an outer surface thereof.

### BACKGROUND OF THE INVENTION

The invention relates generally to a coupling mechanism and, more specifically, to a coupling mechanism for connecting a toolholder assembly and a machine tool.

Various types of mechanisms are known for connecting a toolholder assembly to a machine tool, e.g. a spindle. For such mechanisms it is a desirable objective that proper alignment and orientation be maintained between the toolholder assembly and the machine tool to facilitate proper positioning of a cutting tool with respect to a workpiece. It is also a desirable objective for such mechanisms to allow for multiple types of toolholder assemblies to be used with the machine tool and to have quick-change capability for efficiently attaching and changing between multiple types of toolholder assemblies such as, for example, drills, reamers, millers, turn-cutters, dies, rams and the like. However, there is always a need for improved mechanisms in this field for connecting a toolholder assembly to a machine tool in order to better achieve the described objectives. Thus, the present invention has been developed in view of the foregoing.

### SUMMARY OF THE INVENTION

An aspect of the present invention is to provide a coupling mechanism for connecting a toolholder assembly and a machine tool. The coupling mechanism includes a first component configured for removably securing the toolholder assembly to the machine tool, wherein the first component includes an axial forward end defining a bore that extends axially to an axial rearward end of the first component to form an inner surface of the first component, the first component having a plurality of apertures disposed circumferentially thereabout that extend from an outer surface of the first component to the inner surface of the first component. The coupling mechanism further includes a second component integrally formed with the first component and configured for interacting with the machine tool to position the toolholder assembly relative to the machine tool, wherein the second component defines a positioning groove on an outer surface thereof.

Another aspect of the present invention is to provide a coupling mechanism for connecting a toolholder assembly and a machine tool. The coupling mechanism includes a hollow taper shank having a plurality of apertures disposed circumferentially about the shank, each of the plurality of apertures including a ball track hole adjacent an inner surface of the hollow shank. The coupling mechanism further includes an annular flange axially adjacent the hollow taper shank, wherein the flange defines a positioning groove on an outer surface thereof.

These and other aspects of the present invention will be more fully understood following a review of this specification and drawings.

### BRIEF DESCRIPTION OF THE DRAWINGS

FIG. 1 is an isometric view of a toolholder assembly, in accordance with an aspect of the invention.

FIG. 2 is an elevational side view of the toolholder assembly shown in FIG. 1, in accordance with an aspect of the invention.

FIG. 3 is a sectional view taken along lines 3-3 of FIG. 2, in accordance with an aspect of the invention.

FIG. 4 is a partial isometric view of an additional toolholder assembly, in accordance with an aspect of the invention.

FIG. 5 is a partial side elevational view of the toolholder assembly illustrated in FIG. 4, in accordance with an aspect of the invention.

### DETAILED DESCRIPTION

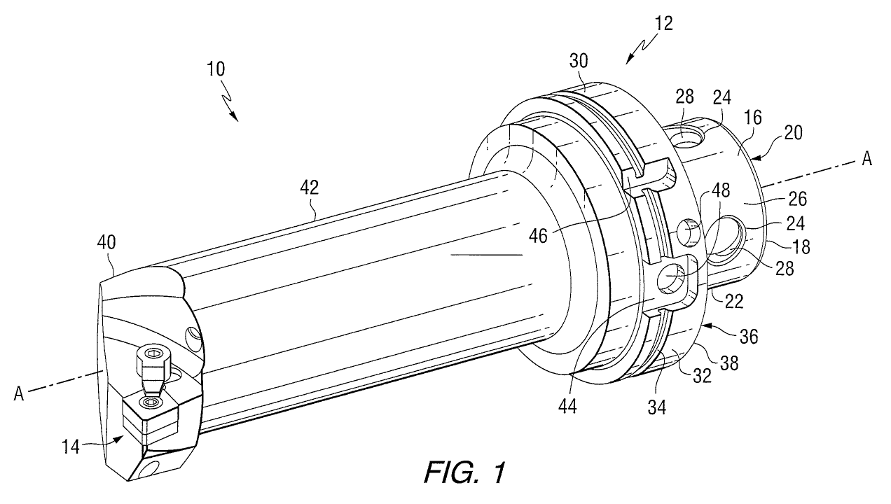

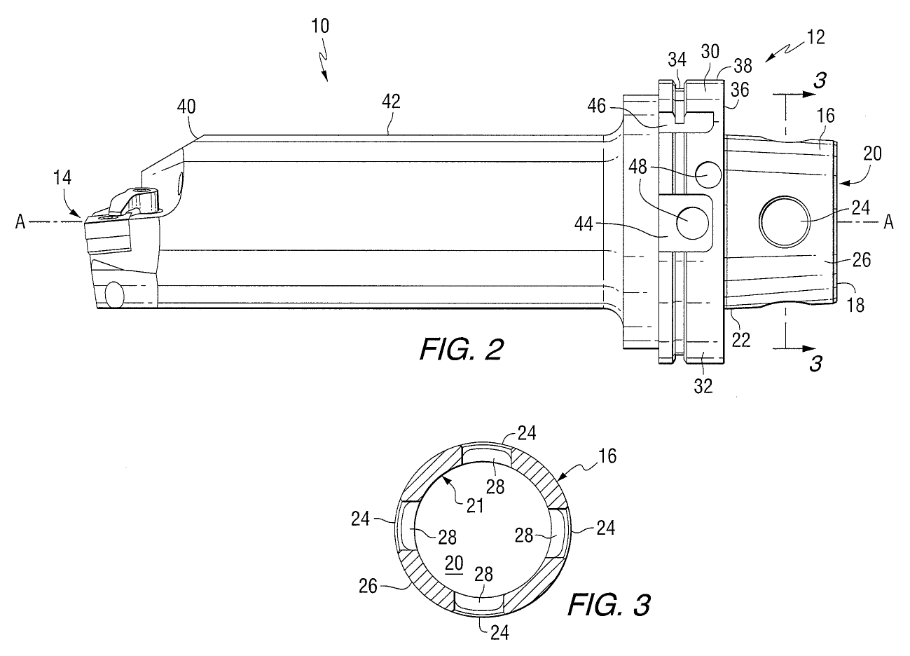

In accordance with an aspect of the invention, FIGS. 1, 2 and 3 illustrate a toolholder assembly 10 having a coupling mechanism, generally designated by reference number 12 for connecting the toolholder assembly 10 to a machine tool (not shown). As will be appreciated from the description set forth herein, the coupling mechanism 12 provides for improved alignment and orientation between the toolholder assembly 10 and the machine tool so as to facilitate proper positioning of a cutting tool, generally designated by reference number 14, with respect to a workpiece (not shown). It will also be appreciated that the coupling mechanism 12 provides for multiple types of toolholder assemblies 10 to be used with the machine tool and to provide for quick change capability for efficiently attaching and changing between multiple types of toolholder assemblies 10 such as, for example, drills, reamers, millers, turn-cutters, dies, rams, and the like.

Still referring to FIGS. 1-3, the improved coupling mechanism 12 generally includes two components for more efficiently connecting the toolholder assembly 10 to the machine tool. Specifically, the first component is a hollow taper shank 16. The hollow taper shank 16 includes an axial forward end 18 that opens to define a bore 20 that extends axially along longitudinal axis A-A to an axial rearward end 22 of the hollow taper shank 16. The bore 20 forms an inner surface 21 (see FIG. 3) of the hollow taper shank 16. In addition, the hollow taper shank 16 tapers from the axial rearward end 22 toward the axial forward end 18.

As further shown in FIGS. 1-3, the hollow taper shank 16 includes a plurality of apertures 24 disposed circumferentially about an outer surface 26 thereof. Each of the apertures 24 extends from the outer surface 26 through the hollow taper shank 16 to the inner surface 21 thereof. In addition, each of the plurality of apertures 24 includes a ball track recess 28 formed adjacent the inner surface 21. Thus, it will be appreciated that the described configuration for the hollow taper shank 16 provides a component for removably securing the toolholder assembly 10 to a machine tool, e.g., to a spindle of a machine tool, using a locking ball arrangement. In one aspect of the invention, the hollow taper shank 16 may have four apertures and four corresponding ball track recesses disposed circumferentially about the outer surface 26. For example, the hollow taper shank 16 may be a 4 ball KM product available from Kennametal Inc., as described in detail in U.S. Pat. Nos. 4,736,659; 4,723,877; 4,747,735; and 6,619,897 all of which are fully incorporated herein by reference.

Still referring to FIGS. 1-3, the second component of the coupling mechanism 12 is an annular flange 30 that is integrally formed with the hollow taper shank 16 and positioned axially adjacent the hollow taper shank 16. The annular flange 30 is configured for interacting with the machine tool to position the toolholder assembly 10 relative to the machine tool. Specifically, the annular flange 30 includes an outer surface 32 which defines a positioning groove 34 that extends at least partially circumferentially about the annular flange 30. In one aspect of the invention, the positioning groove 34 can have a generally V-shaped configuration.

As shown in FIGS. 1-3, the annular flange 30 includes an abutment face 36 at an axial forward end 38 thereof adjacent the axial rearward end 22 of the hollow taper shank 16. The abutment face 36 cooperates with the machine tool in order to further secure the toolholder assembly 10 to the machine tool. In addition, the annular flange 30 includes an axial rearward end 40 at the end of a connecting shank 42 wherein the cutting tool 14 is provided at the axial rearward end 40 for performing a cutting operation on a workpiece. It will be appreciated that in accordance with aspects of the invention, various configurations of connecting shanks 42 and cutting tools 14 may be provided in association with the annular flange 30 in order to provide various types of toolholder assemblies 10.

As further shown in FIGS. 1-3, the annular flange 30 also can include on or adjacent the outer surface 32 a locating slot 44, an orientation notch 46, and/or one or more apertures 48. The slot 44 is to provide error proof capabilities when inserting the toolholder assembly 10 into a storage system and/or mechanical arm for tool changing purposes. This function allows for the proper installation of the toolholder assembly 10 into a machine tool. Orientation notch 46 is an additional feature to assist with proper placement of the toolholder assembly 10 into the correct location within the machine tool. In one aspect, the one or more apertures 48 provides for proper balancing of the toolholder assembly 10. The slot 44 and/or notch 46 may be held to different dimensional sizes thus creating the possibility of an out of balance condition. The one or more apertures 48 can correct this out of balance condition by removing mass from the tool at a pre-described location. In another aspect, the one or more apertures 48 may provide a location for the usage of an RFID (radio frequency identification) if the end user so desires.

It will be appreciated that in accordance with other aspects of the invention, the positioning groove 34, the locating slot 44, orientation notch 46, and/or the balancing apertures 48 may be provided at various positions and locations on the annular flange 30 and that one or more of each of these components may be provided on the annular flange 30 in order to provide various types of toolholder assemblies 10 for cooperating with various types of machine tools. For example, in one aspect of the invention, the annular flange 30 portion of the coupling mechanism 12 may be the flange provided in an “HSK” type flange (“HSK” is a German abbreviation for “Hohlschaftkegelschnittstelle”). More specifically, “HSK” type flanges are described in more detail in ISO 12164 (including but not limited to ISO 12164-1, ISO 12164-2, ISO 12164-3, and ISO 12164-4) entitled Hollow Taper Interface With Flange Contact Surface, all of which are fully incorporated herein by reference. In addition, “HSK” type flanges are also described in more detail in DIN 69893 (including but not limited to DIN 69893-1, DIN 69893-2, DIN 69893-5, and DIN 69893-6) entitled Hollow Taper Shanks—HSK with flat contact surface, all of which are fully incorporated herein by reference.

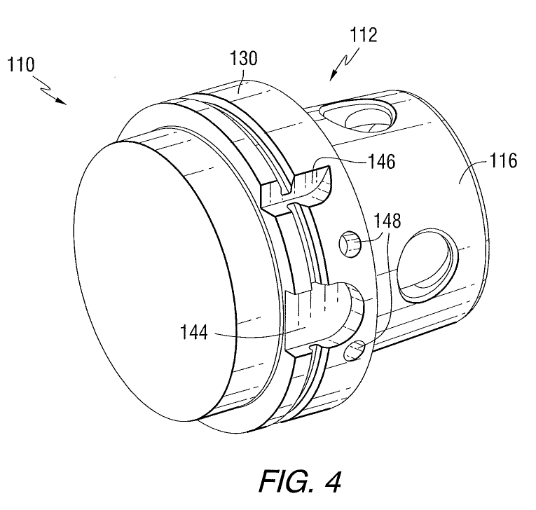

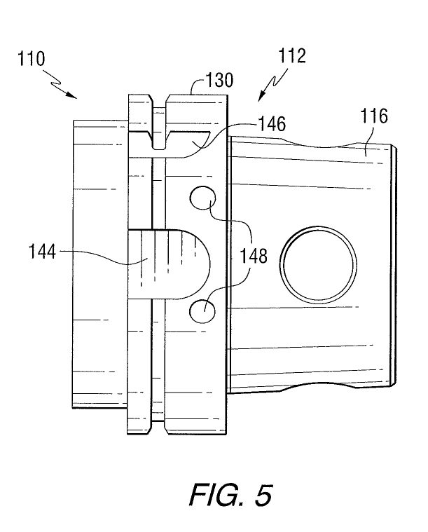

FIGS. 4 and 5 illustrate a partial view of an additional toolholder assembly 110 constructed in accordance with aspects of the invention. In particular, there is shown a coupling mechanism 112 that is similar to the coupling mechanism 12 illustrated and described herein. In particular, the coupling mechanism 112 includes a hollow taper shank 116 constructed similarly to the hollow taper shank 16 described and illustrated herein. In addition, the coupling mechanism 112 includes an annular flange 130 similar to the annular flange 30 described and illustrated herein, except that the orientation of the locating slot 44, orientation notch 46, and the balancing apertures 148 is different than as previously described herein. This illustrates that various configurations of an annular flange may be provided in accordance with aspects of the invention such as, for example, the various types of flanges provided in the various types of “HSK” flanges described and referenced herein.

Whereas particular embodiments of this invention have been described above for purposes of illustration, it will be evident to those skilled in the art that numerous variations of the details of the present invention may be made without departing from the invention as defined in the appended claims.

What is claimed is:

1. A coupling mechanism for connecting a toolholder assembly and a machine tool, the coupling mechanism comprising:
a first component configured for removably securing the toolholder assembly to the machine tool, wherein the first component includes an axial forward end defining a bore that extends axially to an axial rearward end of the first component to form an inner surface of the first component, the first component having a plurality of apertures disposed circumferentially thereabout that extend from an outer surface of the first component to the inner surface of the first component; and
a second component integrally formed with the first component and configured for interacting with the machine tool to position the toolholder assembly relative to the machine tool, wherein the second component defines a positioning groove on an outer surface thereof.

2. The coupling mechanism of claim 1, wherein each of the plurality of apertures includes a ball track recess adjacent the inner surface of the first component.

3. The coupling mechanism of claim 1, wherein the positioning groove is generally V-shaped.

4. The coupling mechanism of claim 1, wherein the second component further defines a locating slot on the outer surface thereof.

5. The coupling mechanism of claim 1, wherein the second component further defines an orientation notch on the outer surface thereof.

6. The coupling mechanism of claim 1, wherein the first component is a taper shank.

7. The coupling mechanism of claim 6, wherein the taper shank tapers from the axial rearward end toward the axial forward end.

8. The coupling mechanism of claim 1, wherein the second component is an annular flange.

9. The coupling mechanism of claim 1, wherein the second component includes an abutment face at an axial forward end thereof adjacent the axial rearward end of the first component.

10. The coupling mechanism of claim 9, wherein the second component further includes a cutting tool adjacent an axial rearward end thereof.

11. A coupling mechanism for connecting a toolholder assembly and a machine tool, the coupling mechanism comprising:
a hollow taper shank having a plurality of apertures disposed circumferentially about the shank, each of the plurality of apertures including a ball track hole adjacent an inner surface of the hollow shank; and
an annular flange axially adjacent the hollow taper shank, wherein the flange defines a positioning groove on an outer surface thereof.

12. The coupling mechanism of claim 11, wherein the positioning groove is generally V-shaped.

13. The coupling mechanism of claim 11, wherein the annular flange further defines a locating slot on the outer surface thereof.

14. The coupling mechanism of claim 11, wherein the annular flange further defines an orientation notch on the outer surface thereof.

15. The coupling mechanism of claim 11, wherein the plurality of apertures consists of four apertures and four corresponding ball track holes.
